(19) United States
(12) Patent Application Publication
(10) Pub. No.: US 2025/0378300 A1
(43) Pub. Date: Dec. 11, 2025

(54) DIGITAL ASSISTANT CREATION

(71) Applicant: Beijing Zitiao Network Technology Co., Ltd., Beijing (CN)

(72) Inventor: Xuewei Jia, Beijing (CN)

(21) Appl. No.: 18/819,182

(22) Filed: Aug. 29, 2024

(30) Foreign Application Priority Data
Jun. 7, 2024 (CN) 202410742949.2

(51) Int. Cl. G06N 3/006; G06F 9/451

(52) U.S. Cl. CPC G06N 3/006; G06F 9/453

(57) ABSTRACT

The embodiments of the invention provide a digital assistant creation method, apparatus, device, storage medium and program product. The method includes: presenting, in a user interface for creating a digital assistant, a configuration region configured to receive settings information for a digital assistant; presenting an optimization panel in response to detecting an automatic optimization indication of the settings information for the digital assistant; presenting, in the optimization panel, at least one adjusted portion of the settings information based on an adjustment indication received via the optimization panel and at least one portion of the settings information received in the configuration region; and determining, based on an acceptance indication or a rejection indication for the at least one adjusted portion of the settings information, the settings information to be presented in the configuration region.

### CROSS-REFERENCE

The present application claims priority to Chinese Patent Application No. 202410742949.2, filed on Jun. 7, 2024, and entitled “DIGITAL ASSISTANT CREATION METHOD, APPARATUS, DEVICE, STORAGE MEDIUM AND PROGRAM PRODUCT”, the entirety of which is incorporated herein by reference.

### FIELD

Example embodiments of the present disclosure generally relate to the field of computers, and more particularly, to digital assistant creation.

### BACKGROUND

Digital assistants are provided to assist users in various task processing needs in different applications and scenarios. Digital assistants usually have intelligent dialogue and task processing capabilities. In the process of the interaction with digital assistants, users input interactive messages, and digital assistants respond to the user input to provide reply messages. Typically, digital assistants can support the input of a user's questions in natural language format and perform tasks and provide responses based on the digital assistant's understanding of the natural language input and logical reasoning ability. Such interaction methods have become tools that people love and rely on due to their flexible and convenient characteristics.

### SUMMARY

In a first aspect of the present disclosure, a method for digital assistant creation is provided. The method comprises the following steps: in a user interface configured for creating a digital assistant, presenting a configuration region configured for receiving settings information for a digital assistant, wherein the settings information is configured to generate a prompt input for the first machine learning model, wherein the digital assistant generates a response to the user based on an output of the first machine learning model; in response to detecting an automatic optimization indication of the settings information for the digital assistant, presenting an optimization panel, wherein the optimization panel comprises at least one of the following: an input control for receiving an input of an adjustment indication for the settings information, or at least one instruction control, each instruction control corresponding to an adjustment indication for the settings information; presenting at least one adjusted portion of the settings information in the optimization panel based on an adjustment indication received via the optimization panel and at least one portion of the settings information received in the configuration region; and determining the settings information to be presented in the configuration region based on an acceptance indication or a rejection indication for the at least adjusted portion of the settings information.

In a second aspect of the present disclosure, an apparatus for digital assistant creation is provided. The apparatus includes: a configuration region presenting module configured to present, in a user interface for creating a digital assistant, a configuration region for receiving settings information for the digital assistant, the settings information being configured to generate a prompt input for a first machine learning model, wherein the digital assistant generates a response to a user based on an output of the first machine learning model; an optimization panel presenting module configured to present an optimization panel in response to detecting an automatic optimization indication of the settings information for the digital assistant, the optimization panel comprising at least one of the following: an input control configured to receive an input of an adjustment indication for the settings information or at least one instruction control, each instruction control corresponding to an adjustment indication for the settings information; a settings information presenting module configured to present at least one adjusted portion of the settings information in the optimization panel based on the adjustment indication received via the optimization panel and at least one portion of the settings information received in the configuration region; and a settings information determining module configured to determine the settings information to be presented in the configuration region based on an acceptance indication or a rejection indication for the at least one adjusted portion of the settings information.

In a third aspect of the present disclosure, an electronic device is provided. The device includes at least one processing unit; and at least one memory coupled to the at least one processing unit and storing instructions for execution by the at least one processing unit, wherein the instructions, when executed by the at least one processing unit, cause the electronic device to perform operations that implement the method of the first aspect.

In a fourth aspect of the present disclosure, a computer-readable storage medium is provided. The computer-readable storage medium stores a computer program, and the computer program is executable by the processor to implement the method of the first aspect.

In a fifth aspect of the present disclosure, a computer program product is provided. The computer program product includes computer-executable instructions that, when executed by a processor, implement the method of the first aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment.

FIG. 2 illustrates an example of a user interface for creating a digital assistant.

FIGS. 3A to 3N illustrate schematic diagrams of example configuration regions.

FIG. 4 shows a flowchart of an example process for digital assistant creation.

FIG. 5 shows a schematic structural block diagram of an example apparatus for digital assistant creation.

FIG. 6 illustrates a block diagram of an example electronic device in which one or more embodiments of the present disclosure may be implemented.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

Unless expressly stated herein, performing a step “in response to A” does not mean that the step is performed immediately after “A”, but may include one or more intermediate steps.

It will be appreciated that the data involved in this technical solution (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, wherein the relevant user may include any type of rights subject, such as individuals, enterprises, groups.

For example, in response to receiving an active request from a user, a prompt message is sent to the user to explicitly prompt the user that the operation requested operation by the user will need to obtain and use the user's personal information, so that users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used in this specification, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

Digital assistants can serve as effective tools for people's work, study, and life. In general, the development of digital assistants is similar to the development of general applications, requiring developers having programming skills to define the various capabilities of digital assistants by writing complex code, and deploying digital assistants on appropriate operating platforms so that users can download, install, and use digital assistants.

With the diversification of application scenarios and the availability of machine learning technologies increasing, it is desirable to develop digital assistants with different capabilities to support task processing in various fields, or to meet personalized requirements of different users. The user may create different prompts and provide the prompts to a machine learning model to determine different digital assistants by utilizing the machine learning model. The user may also adjust the digital assistant by adjusting the prompt. Traditionally, users often need to manually determine which content of the prompt needs to be modified, and manually modify the prompt. However, due to their programming capability and limited understanding of the underlying implementation logic of the digital assistant, users cannot accurately adjust the prompt, and the efficiency of manually adjusting the prompt is poor. Therefore, this specification describes technologies configured to determine a more accurate prompt conveniently and quickly, such that more users can obtain their desired digital assistant.

According to embodiments of the present disclosure, an improved solution for digital assistant creation is provided. According to this solution, in a user interface for creating a digital assistant, a configuration region configured for receiving settings information for a digital assistant is presented. The settings information is configured to generate a prompt input for the first machine learning model. A response of the digital assistant to the user is determined based on an output of the first machine learning model. In response to detecting an automatic optimization indication of the settings information for the digital assistant, an optimization panel is presented. The optimization panel includes at least one of: an input control configured to receive an input of an adjustment indication for the settings information or at least one instruction control where each instruction control corresponds to an adjustment indication for the settings information. Based on the adjustment indication received via the optimization panel and at least one portion of the settings information received in the configuration region, at least one adjusted portion of the settings information is presented in the optimization panel. The settings information to be presented in the configuration region is determined based on an acceptance indication or a rejection indication for the at least one adjusted portion of the settings information.

Therefore, in the process of digital assistant creation, the user can conveniently and quickly adjust the prompt input to adjust the response result of the digital assistant accordingly.

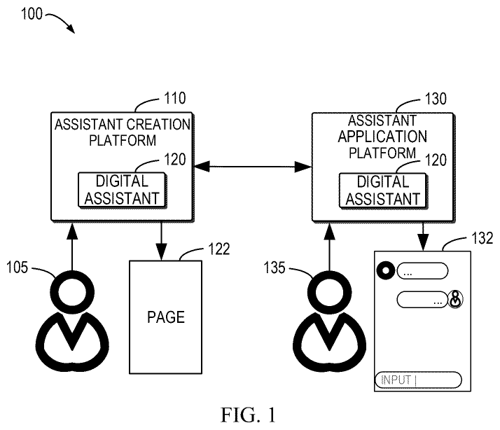

FIG. 1 illustrates a schematic diagram of an example environment 100 in which embodiments of the present disclosure can be implemented. The environment 100 relates to an assistant creation platform 110 and an assistant application platform 130.

As shown in FIG. 1, the assistant creation platform 110 may provide a creation and releasing environment of a digital assistant for a user 105. In some embodiments, the assistant creation platform 110 may be a low-code platform that provides a collection of tools for the digital assistant creation. The assistant creation platform 110 may support visual development of the digital assistant, thereby allowing developers to skip the manual coding process, accelerate the development cycle, and reduce the cost of applications. The assistant creation platform 110 may support any suitable platform for users to develop digital assistants and other types of applications, for example, it can include platforms based on application platform-as-a-service (aPaaS). Such a platform can support users to efficiently develop applications, achieve application creation, application function adjustment, and other operations.

The assistant creation platform 110 may be deployed locally on a terminal device of the user 105 and/or may be supported by a remote server. For example, the terminal device of the user 105 may run a client of the assistant creation platform 110, and the client may support the interaction between the user and the assistant creation platform 110. In the case where the assistant creation platform 110 is run locally on the user's terminal device, the user 105 can directly use the client to interact with the local assistant creation platform 110. In the case where the assistant creation platform 110 is run on a server-side device, the server-side device may implement the provision of services to the client running on the terminal device based on a communication connection between the assistant creation platform 110 and the terminal device. The assistant creation platform 110 may present a corresponding page 122 to the user 105 based on an operation of the user 105 so as to output information to the user 105/or receive information from the user 105.

In some embodiments, the assistant creation platform 110 may be associated with a corresponding database, which stores data or information required for the digital assistant creation process supported by the assistant creation platform 110. For example, the database may store codes and descriptive information corresponding to various function modules that make up the digital assistant. The assistant creation platform 110 may also perform operations on the functional modules in the database, such as invoking, adding, deleting, updating, and the like. The database may also store operations that can be performed on different functional blocks. For example, in a scenario in which a digital assistant is to be created, the assistant creation platform 110 may invoke a corresponding function block from the database to build the digital assistant.

In embodiments of the present disclosure, the user 105 may create a digital assistant 120 on the assistant creation platform 110 and release the digital assistant 120 as needed. The digital assistant 120 may be released to any suitable assistant application platform 130, as long as the assistant application platform 130 can support the execution of the digital assistant 120. After the digital assistant 120 is released, it may be used for conversational interaction with a user 135. The client of the assistant application platform 130 may present an interaction window 132 of the digital assistant 120 in the client interface, such as the conversation window. The digital assistant 120, as an intelligent assistant, has intelligent conversation and information processing capabilities. The user 135 may enter a conversation message in the conversation window, and the digital assistant 120 may determine a reply message based on created configuration information and present it to the user in the interaction window 132. In some embodiments, depending on the configuration of the digital assistant 120, the interaction message with the digital assistant 120 may comprise messages in various multimodal message formats such as text messages (e.g., natural language text), voice messages, image messages, video messages, and so on.

The assistant creation platform 110 and/or the assistant application platform 130 may run on an appropriate electronic device. The electronic device herein may be any type of device having computing capability, comprising a terminal device or a server-side device. The terminal device may be any type of mobile terminal, fixed terminal, or portable terminal, comprising a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, comprising accessories and peripherals of these devices, or any combination thereof. The server device may include, for example, a computing system/server, such as a mainframe, an edge computing node, a computing device in a cloud environment, or the like. In some embodiments, assistant creation platform 110 and/or assistant application platform 130 may be implemented based on cloud services.

It will be appreciated that the structure and function of the environment 100 are described for the purposes of illustration only, without implying any limitation on the scope of the present disclosure. For example, although FIG. 1 shows a single user interacting with the assistant creation platform 110 and a single user interacting with the assistant application platform 130, but multiple users can actually access the assistant creation platform 110 to create a digital assistant respectively, and each digital assistant can be used to interact with multiple users.

Some example embodiments of the present disclosure will be described in detail below with reference to examples of the accompanying drawings. It will be appreciated that pages/interfaces shown in the figures are merely examples and various page/interface designs may be present. Individual graphical elements in a page/interface may have different arrangements and different visual representations, one or more of which may be omitted or replaced, and one or more other elements may also be present. Embodiments of the present disclosure are not limited in this respect.

The digital assistant creation process described in the embodiments of the present disclosure may be implemented on the assistant creation platform, a terminal device on which the assistant creation platform is installed, and/or a server corresponding to the assistant creation platform. In the following examples, for discussion purposes, the description is made from the perspective of the assistant creation platform, such as the assistant creation platform 110 shown in FIG. 1. The interface presented by the assistant creation platform 110 may be presented via a terminal device of the user 105 and the user input be received via the terminal device of the user 105. Herein, the user 105 creating the digital assistant may be also referred to as an assistant creator, assistant developer, or the like.

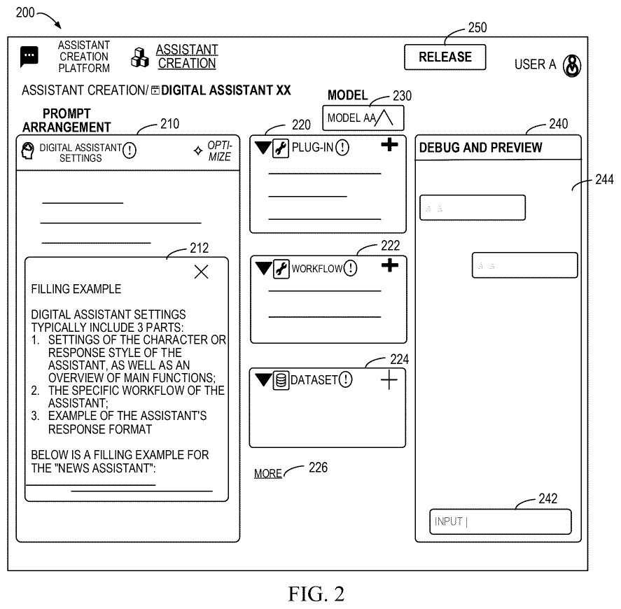

The user 105 may initiate a creation request to the assistant creation platform 110 as needed. In response to receiving the creation request, the assistant creation platform 110 presents an interface for creating a digital assistant. In this interface, the user 105 may configure the digital assistant to be created (for example the digital assistant 120 shown in FIG. 1). Rather than creating a digital assistant by writing code, in embodiments of the present disclosure, an interface for creating a digital assistant is designed to include at least one configuration region configured for receiving configuration information for the digital assistant. Each configuration region is defined to receive a class of configuration information required for building the digital assistant. FIG. 2 illustrates an example of a user interface 200 for creating the digital assistant 120, in accordance with some embodiments of the present disclosure.

Specifically, the user interface includes at least a first configuration region configured for receiving settings information that is input in natural language. For example, the user interface 200 of FIG. 2 presents a configuration region 210 that includes an input box configured for receiving settings information input by a user in natural language.

The received settings information is used as a portion of the configuration information of the digital assistant 120 and will be configured for generating a prompt input for a first machine learning model, and a response of the digital assistant 120 to the user is determined based on an output of the first machine learning model. That is, the digital assistant 120 to be created will determine the user demand corresponding to the user input by means of the first machine learning model and provide a response to the user based on the output of the first machine learning model. The first machine learning model used by the digital assistant 120 may run locally on the assistant creation platform 110 or on a remote server. In some embodiments, the first machine learning model may be based on any suitable model structure, comprising but not limited to, a Transformer model, a convolutional neural network (CNN), a recurrent neural network (RNN), a deep neural network (DNN), or the like. In some embodiments, the first machine learning model may be based on a language model (LM). The language model can have question-answering capability by learning from a large corpus of data. The first machine learning model may also be based on any other suitable model. The specific configuration region is provided in the creation process to allow the user to provide settings information, and the configuration for the settings information can be achieved using natural language inputs. In this way, the user can conveniently constrain the output of the model and configure diversified digital assistants.

In some embodiments, the user interface may further include a second configuration region configured to receive a configuration of at least one processing component. The configuration of the processing component(s) indicates at least one processing component that can be used by the digital assistant 120 when processing the user request. In some embodiments, when the created digital assistant 120 having the configuration of the processing component(s) is interacting with the user, the model may be provided with the configuration of the processing component(s) and the model may determine which processing component(s) are to be used for processing the user input to determine a response to the user.

Each processing component may be understood as a tool that the digital assistant 120 may invoke when processing the user request, and each processing component can perform a corresponding function or service. The types of processing components may be very diverse. The processing component may be selected, configured, or modified by the user 105 from existing processing components. Alternatively, the user 105 may be allowed to customize one or more processing components. As shown in FIG. 2, the user interface 200 is configured for receiving a configuration of at least one processing component, and the user interface 200 includes configuration regions 220, 222, 224, and the like. The configuration of the processing components will be described in more detail below.

By understanding the user demand by means of the model and the settings information, and executing the user demand by means of the processing component, the digital assistant 120 can have the function of interacting with the user and responding to the user request. The user interface for creating the digital assistant can be templated to provide various types of configuration regions within the user interface for receiving configuration information of the digital assistant 120, such that the user 105 can achieve the customization of the digital assistant 120 without performing complex configurations or coding.

In some embodiments, assistant creation platform 110 may provide a creation portal for the digital assistant in any suitable user interface. A user may access a user interface for creating a digital assistant by triggering the creation portal. Based on the input by the user 105 in the user interface for creating the digital assistant, the configuration information received in the user interface may be obtained. The configuration information includes at least settings information received in the first configuration region. Upon completion of the configuration, user 105 may be also allowed to release the created digital assistant. In response to receiving the publication request, the assistant creation platform 110 releases the digital assistant 120 for interaction with the user based on the configuration information received in the user interface. As shown in FIG. 2, the user interface 200 presents a publication control 250. In response to detecting a trigger on the publication control 250, the assistant creation platform 110 receives the user's publication request and releases the digital assistant 120 based on the configuration information received in user interface 200.

In some embodiments, the created digital assistant 120 may be released to a default platform for running. In some embodiments, a candidate platform may be provided for user selection. In response to receiving the publication request, the assistant creation platform 110 may provide at least one candidate platform each supporting execution of the digital assistant 120. If confirmation for a target platform in the at least one candidate platform is received, the digital assistant 120 is released to the target platform, such as the assistant application platform 130 in FIG. 1.

In some embodiments, the settings information may indicate a definition of a response style of the digital assistant 120 to be created. With the response style being set, responses of the created digital assistant can be differentiated, and specific characters can be presented to the user. Alternatively or additionally, in some embodiments, the settings information may indicate a description of functions to be supported by the digital assistant 120 to be created. For example, in the configuration region 210 of the user interface 200, the user 105 may be allowed to input “You are a movie narrator, please use sharp and humorous language to explain the plot of movies to the user and introduce newly released movies.” Such settings information may guide the response style of the digital assistant 120 (e.g., “sharp and humorous”) and describe the functionality of the digital assistant 120 (e.g., “movie narration,” “explain the plot of movies,” “introduce newly released movies”).

In some embodiments, the settings information may alternatively or additionally indicate at least one workflow to be performed by the digital assistant 120 to be created. Each workflow may correspond to various operations of the digital assistant 120 when performing a particular function. That is, the user 105 may be allowed to describe how the digital assistant 120 is to perform a certain function in natural language.

In some embodiments, the settings information may alternatively or additionally indicate at least one response format of the digital assistant 120 to be created. The response format may include, for example, a Markdown (a lightweight markup language) or the like.

It will be understood that only examples of the settings information are given above, and embodiments of the present disclosure are not limited in this respect. In fact, because the settings information is used for constructing the prompt input for the model, the user may be allowed to freely try different settings information to construct a digital assistant that conforms to the user's expectations. For example, in settings information, user 105 may be allowed to input a requirement for the language of the response of the digital assistant 120 and a constraint on the response content of the digital assistant 120 (e.g., the number of words of different types of responses, the type of the response content, etc.)

In some embodiments, to better guide the user to complete the configuration of the digital assistant 120, a settings information example may also be provided in the user interface to guide the user to provide the settings information for the digital assistant 120. The settings information example may be provided at a location associated with the first configuration region for receiving the settings information. As shown in FIG. 2, a settings information example 212 may be provided near the configuration region 210, which may indicate to the user general constituent parts of the settings information for the digital assistant 120, and specific settings information for a certain digital assistant may be provided as an example for reference.

In some embodiments, selection or configuration options for one or more types of processing components may be provided for selection, enablement, or specific configuration by the user 105 as desired.

In some embodiments, the second configuration regions may include a region for plug-in configuration, such as configuration region 220 shown in FIG. 2. In this region, at least one plug-in to be used by the digital assistant 120 may be selected or customized by the user. Each plug-in is configured to perform a corresponding function. For example, a search plug-in may perform a data search function; a browser plug-in may provide a webpage browsing function; a music plug-in may provide a music search and play function, and so on. Additionally, each plug-in may be considered as an atomic capability of the digital assistant 110. The digital assistant 120 may invoke one or more plug-ins to process the user request. In some embodiments, the assistant creation platform 110 may provide a library of plug-ins from which the user 105 can select a plug-in that has been developed from the library. In some embodiments, alternatively or additionally, the assistant creation platform 110 may provide a plug-in definition interface for the user 105 to define plug-ins with specific functionality as needed.

In some embodiments, the second configuration regions may include a region for workflow configuration, such as configuration region 222 shown in FIG. 2. In this region, at least one workflow to be executed by the digital assistant 120 may be selected or customized by the user. The workflow may be input in the settings information in a natural language format. Alternatively or additionally, a workflow portal can be provided such that the user 105 can select an existing workflow, or a workflow may be defined through a dedicated interface.

In some embodiments, the second configuration regions may include a region for workflow configuration, such as configuration region 224 shown in FIG. 2. In this region, at least one dataset may be selected by the user, and the digital assistant 120 utilizes the at least one dataset to determine a response to the user. Here, a “dataset” may also be referred to as a “knowledge base”. When determining a response to the user, the digital assistant 120 may retrieve corresponding knowledge from the configured dataset to determine the response. In some embodiments, the assistant creation platform 110 may allow user 105 to configure the dataset of the digital assistant 120 by selecting from existing datasets, uploading local datasets, or specifying online datasets, etc.

It will be appreciated that the second configuration region may further include a further region, for example, a region for configuring persistent storage information, a region for configuring a task, and the like. This is not limited in the present disclosure. Example 200 may also include a control 226. For example, the assistant creation platform 110 may present a further second configuration region in response to receiving a trigger operation on the control 226.

As previously mentioned, the digital assistant 120 may understand the user request and determine a response to the user by means of a model. In some embodiments, the model used by the digital assistant 120 may be a default model without any creator configuration. In some embodiments, in the process of creating the digital assistant 120, the creator may be allowed to select a model to be used. A third configuration region may be provided in the user interface for creating the digital assistant for receiving a selection of the model. The selected model is invoked to determine a response to the user at the digital assistant 120. As shown in FIG. 2, the user interface 200 also includes a third configuration region 230 for model configuration in which the user 105 may be allowed to select the model to use.

The processing components that are configurable during the digital assistant creation process are discussed above. In particular applications, the configurations of more, fewer, or different processing components may be provided by the assistant creation platform for the selection or configuration by the creator of the digital assistant.

In some embodiments, to enable the user 105 who creates the digital assistant to conveniently test the running effect of the created digital assistant 120 in the creation process, a debugging region for the digital assistant may also be provided in the user interface, such as the debugging region 240 shown in FIG. 2. The debugging region 240 includes an input region 242 for receiving a debugging request for the digital assistant 120, and also includes a presentation region 244 for providing a debugging result for the debug request (and providing the received debug request). The debugging region 240 may be configured in the form of an interactive window to simulate an interactive interface viewed by an interactive user of the digital assistant 120.

In the debugging process, the debugging result presented in the debugging region 240 may be determined based on the received debugging request and the current configuration information for the digital assistant 120 in the user interface 200. The user 105 may determine, according to the debugging result, whether the actual running result of the digital assistant 120 meets expectations, whether to continue to modify the configuration information, or determine to release the digital assistant. In some embodiments, for each debugging process, in addition to the debugging result, an underlying running process of the digital assistant 120 determining the debugging result may be provided. For example, the invocation to the model, a thinking process of the model, one or more used plug-ins, and the like, may be provided. This can allow the user 105 to determine whether the currently configured digital assistant meets expectations more quickly.

The process of the digital assistant creation according to some embodiments of the present disclosure is described above. In embodiments of the present disclosure, the assistant creation platform provides sufficient support for the constituent parts of the digital assistant, thereby enabling the user to create their desired digital assistant conveniently, quickly, flexibly and freely.

In embodiments of the present disclosure, the assistant creation platform 110 presents a configuration region (e.g., configuration region 210) for receiving settings information for the digital assistant in a user interface (e.g., user interface 200) configured for creating the digital assistant. As mentioned above, the settings information is configured for generating a prompt input for the first machine learning model, and the response to the user by the digital assistant is determined based on the output of the first machine learning model. In response to detecting an automatic optimization indication for the settings information for the digital assistant, the assistant creation platform 110 presents an optimization panel.

The optimization panel may include an input control for receiving an input of an adjustment indication for the settings information. The input control may include any suitable input control such as an input box, a voice input control, an attachment uploading control, and the like. The assistant creation platform 110 may receive information of a text type via an input box. The assistant creation platform 110 may receive information of a voice type via a voice input control. The assistant creation platform 110 may receive information of types of images, videos, documents, and the like via an attachment upload control. The assistant creation platform 110 may adjust the settings information based on the information received via the input control. In some embodiments, assistant creation platform 110 may also receive a user-provided access link via an input box. The assistant creation platform 110 may automatically extract the content of the access link. For example, if the assistant creation platform 110 receives a webpage link provided by the user via the input box, the assistant creation platform 110 may automatically extract the webpage content corresponding to the webpage link.

The optimization panel may also include at least one instruction control. Each instruction control corresponds to an adjustment indication for the settings information. Each instruction control may correspond to a shortcut instruction, which may facilitate the user to quickly trigger the instruction control to input a corresponding adjustment indication. The at least one instruction control and the shortcut instruction corresponding to each instruction control may be predefined by the user, for example. In some examples, the at least one instruction control and the shortcut instruction corresponding to each instruction control may be determined by the assistant creation platform 110 based on historical user operation. The present disclosure does not limit the specific determining manner of the at least one instruction control and the shortcut instruction corresponding to each instruction control. The at least one instruction control may include, for example, a first instruction control indicating a global adjustment of the settings information. The at least one instruction control may further include, for example, a second instruction control indicating an adjustment of the settings information based on a debugging result of the digital assistant. The at least one instruction control may further include any other suitable instruction control, which is not limited in the present disclosure.

The assistant creation platform 110 presents at least one adjusted portion of the settings information in the optimization panel based on an adjustment indication received via the optimization panel and at least one portion of the settings information received in the configuration region. In some embodiments, the assistant creation platform 110 may determine, based on the adjustment indication received via the optimization panel and at least one portion of the settings information received in the configuration region, the at least one adjusted portion of the settings information. Specifically, the assistant creation platform 110 may provide the adjustment indication received via the optimization panel and at least one portion of the settings information received in the configuration region to a second machine learning model and determine the at least one adjusted portion of the settings information based on a model output that is fed back by the second machine learning model.

This second machine learning model may be the same model as the first machine learning model or may be a different model from the first machine learning model. The second machine learning model may also have any suitable model structure. The specific process of the assistant creation platform 110 using the second machine learning model to determine the at least one adjusted portion of the settings information is described in detail below with reference to specific embodiments. After the assistant creation platform 110 determines the at least one adjusted portion of the settings information, the assistant creation platform 110 may present the at least one adjusted portion of the settings information in the optimization panel.

The assistant creation platform 110 then determines the settings information to be presented in the configuration region based on an acceptance indication or a rejection indication for the at least one adjusted portion of the settings information. For example, if an acceptance indication for at least one adjusted portion of the settings information is received, it is determined that the at least one adjusted portion of the settings information is to be presented in the configuration region. If the rejection indication for at least one adjusted portion of the settings information is received, it is determined that the previous settings information is to be presented in the configuration region (that is, no adjustment is performed on the settings information).

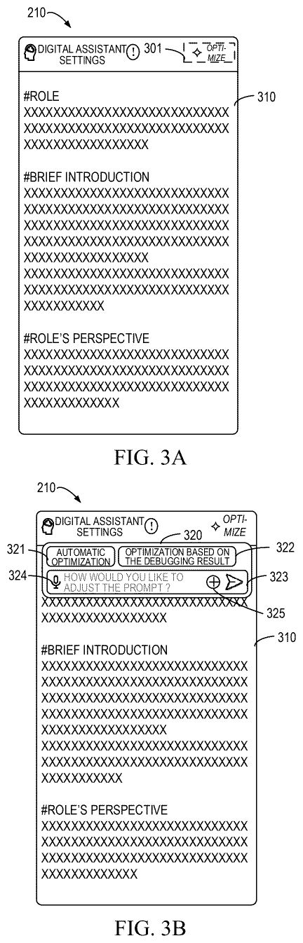

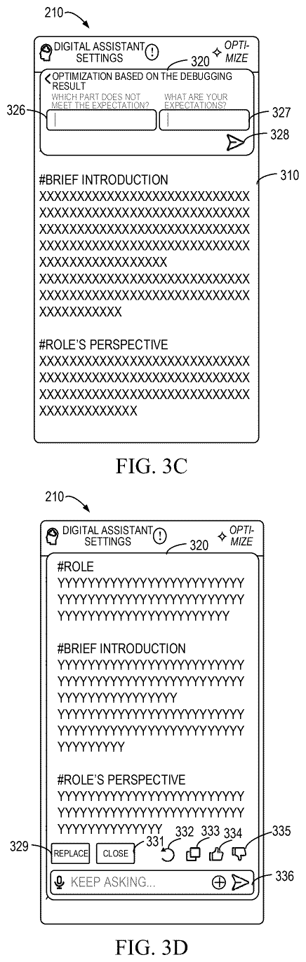

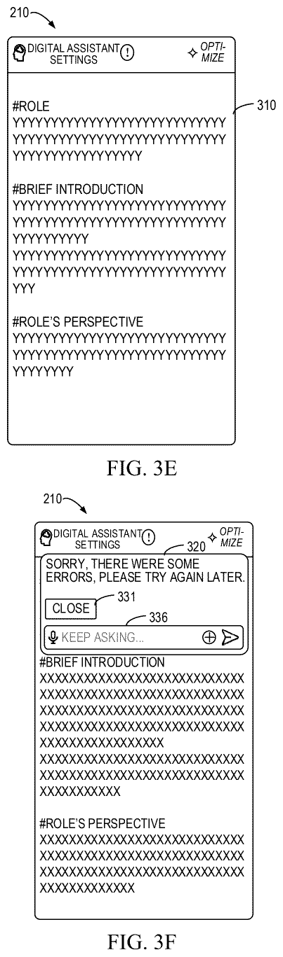

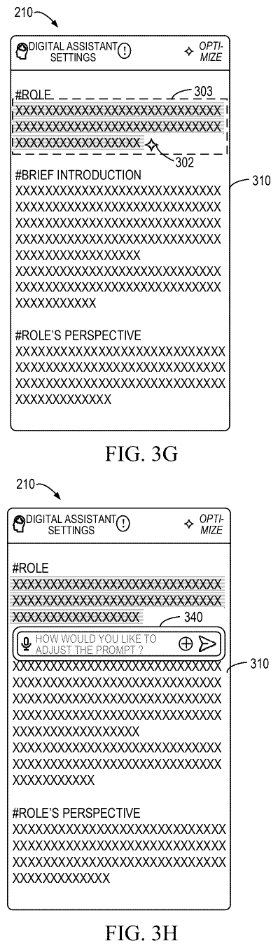

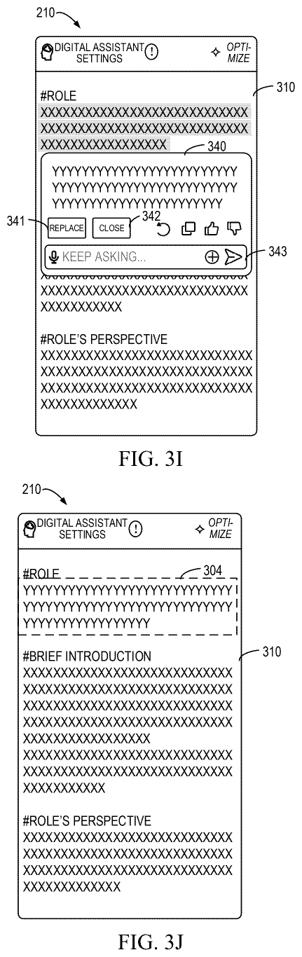

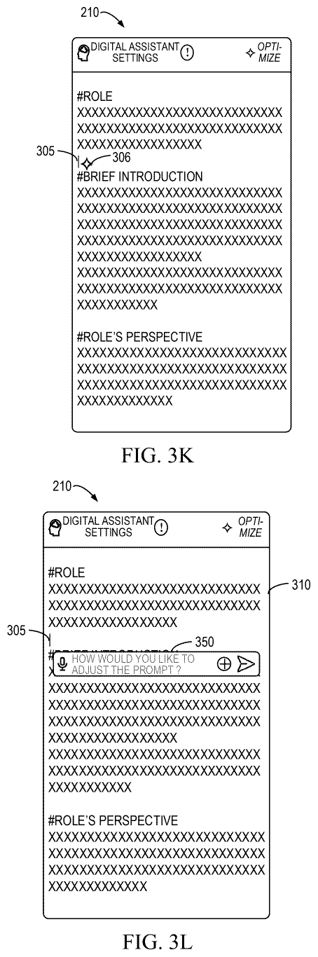

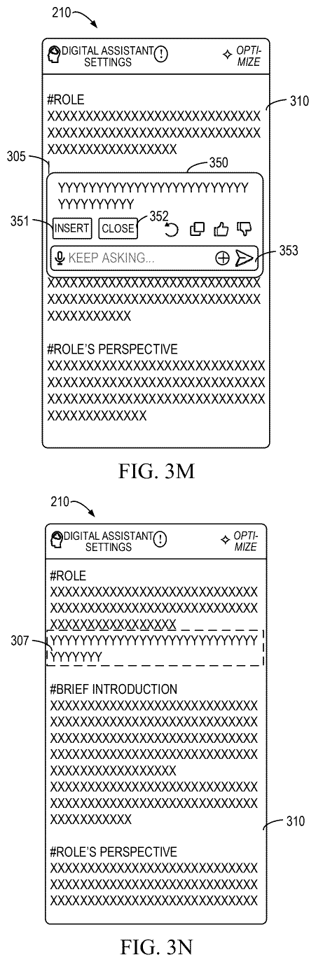

Specific manners of adjusting the settings information are described below with reference to FIG. 3A to FIG. 3N. FIGS. 3A to 3N illustrate schematic diagrams of example configuration regions (e.g., configuration region 210), in accordance with some embodiments of the present disclosure.

In some embodiments, the assistant creation platform 110 may detect an automatic optimization indication for the settings information for the digital assistant in response to receiving a trigger on a predetermined interface element in the user interface (e.g., user interface 200 shown in FIG. 2). The predetermined interface element may include at least one interface element. For example, the predetermined interface element may include a first interface element presented at a predetermined location near the configuration region, a second interface element to be presented in association with at least one portion of the settings information, a third interface element presented at a current input location in the configuration region, and/or the like.

For the first interface element, the predetermined location near the configuration region may be any suitable location, which may be located around the configuration region or may be located in the configuration region. For example, as shown in FIG. 3A, the configuration region 210 may include a region 310 configured for presenting the settings information. The assistant creation platform 110 may present a first interface element 301 at a predetermined location near the configuration region 210 (e.g., the upper right corner of the configuration region 210). The assistant creation platform 110 may detect the automatic optimization indication in response to a trigger on the first interface element 301.

In some embodiments, the assistant creation platform 110 may present an optimization panel comprising an input control and/or at least one instruction control in response to detecting the automatic optimization indication for the settings information for the digital assistant. For example, the assistant creation platform 110 may present, in response to detecting the automatic optimization indication for the settings information for the digital assistant, the configuration region 210 as shown in FIG. 3B. In FIG. 3B, the configuration region 210 includes an optimization panel 320. The optimization panel 320 includes an input control, an instruction control 321 (which may be, for example, a first instruction control corresponding to a first shortcut instruction), and an instruction control 322 (which may be, for example, a second instruction control corresponding to a second shortcut instruction). The input control may include, for example, an input box 323, a voice input control 324, and an attachment uploading control 325.

In some embodiments, the assistant creation platform 110 may automatically adjust the settings information to generate the adjusted settings information in response to receiving a trigger on the instruction control 321 in the optimization panel. For example, the assistant creation platform 110 may, for example, provide at least one portion of the settings information received by the configuration region and the first shortcut instruction corresponding to the instruction control 321 to the second machine learning model, and instruct the second machine learning model to expand the settings information to expand the relatively brief content in the settings information into richer and professional content. As another example, the assistant creation platform 110 may provide the first shortcut instruction and at least one portion of the settings information received by the configuration region to the second machine learning model, and instruct the second machine learning model to adjust the structure of the settings information. In some embodiments, the assistant creation platform 110 may determine a modification recommendation for the settings information only by means of the second machine learning model, and the assistant creation platform 110 may provide the modification recommendation to the user such that the user can adjust the settings information based on the modification recommendation on their own.

For example, if the assistant creation platform 110 detects the automatic optimization indication in response to the trigger on the first interface element, and receives a trigger on the instruction control 321, because the first interface element is directed to an entirety of the settings information in the configuration region, the assistant creation platform 110 may determine the adjusted settings information based on the entirety of the settings information received in the configuration region and the first shortcut instruction corresponding to the instruction control 321.

In some embodiments, because the second instruction control (e.g., instruction control 322) indicates adjustment of the settings information based on the debugging result of the digital assistant, in order to determine which part of the debugging result the user is unsatisfied with, and determine what kind of debugging result the user desires to obtain, the assistant creation platform 110 may further present a first input control and a second input control in the optimization panel in response to receiving the trigger on the second instruction control in the optimization panel. The assistant creation platform 110 may receive, via the first input control, a content to be adjusted in the debugging result of the digital assistant, and may receive, via the second input control, an adjustment target for the content to be adjusted.

For example, as shown in FIG. 3B and FIG. 3C, the assistant creation platform 110 may, for example, in response to receiving a trigger on the instruction control 322 in the optimization panel 320 in FIG. 3B, present the configuration region 210 shown in FIG. 3C. In FIG. 3C, the assistant creation platform 110 may present an input control 326 (i.e., the first input control) and an input control 327 (i.e., the second input control) in the optimization panel 320. In an example where the user is unsatisfied with content A of the debugging result and expects that content B is included in the debugging result, the assistant creation platform 110 may receive the text “content A” via the input control 326 and receive the text “the debugging result includes content B instead of content A” via the input control 327. The optimization panel 320 may further include a control such as a control 328. The assistant creation platform 110, for example, may determine, in response to receiving a trigger on the control 328, at least one adjusted portion of the settings information based on the content received via the input control 326 and the content received via the input control 327.

Therefore, if the user finds that the debugging result is unsatisfactory in the debugging process of the digital assistant, and the user has an explicit adjustment expectation, but does not know which aspect of the settings information for the digital assistant shall be specifically adjusted, the user can trigger the second instruction control and input, via the first input control and the second input control, an unsatisfactory part of the debugging result and an adjustment target. Then the assistant creation platform 110 may automatically adjust the settings information based on the content entered by the user, such that the settings information can be adjusted conveniently and quickly.

In some embodiments, if the trigger on the second instruction control is received, the assistant creation platform 110 may provide, to the second machine learning model, at least one portion of the settings information in the configuration region, the content to be adjusted in the debugging result of the digital assistant received via the first input control, the adjustment target for the content to be adjusted received via the second input control, and the second shortcut instruction corresponding to the second instruction control. The assistant creation platform 110 may determine the at least one adjusted portion of the settings information based on a model output provided by the second machine learning model. For example, if the assistant creation platform 110 detects the automatic optimization indication in response to the trigger on the first interface element, and receives the trigger on the second instruction control, the assistant creation platform 110 may determine the adjusted settings information based on the second shortcut instruction, the content to be adjusted in the debugging result of the digital assistant, the adjustment target for the content to be adjusted, and the entirety of the settings information received in the configuration region.

In some embodiments, in response to receiving the trigger on the second instruction control in the optimization panel, the assistant creation platform 110 may determine at least one adjusted portion of the settings information based on the received content to be adjusted, the adjustment target, at least one historical debugging instruction for the digital assistant, and at least one portion of the settings information received in the configuration region. Here, the at least one historical debugging instruction may include, for example, at least one historical adjustment dialogue between the user and the digital assistant. For example, the assistant creation platform 110 may provide, to the second machine learning model, the adjustment indication received via the optimization panel, the received content to be adjusted, the adjustment target, at least one historical debugging instruction for the digital assistant, and at least one portion of the settings information received in the configuration region. The assistant creation platform 110 may determine, based on a model output returned by the second machine learning model, at least one adjusted portion of the settings information.

Further, if the assistant creation platform 110 detects the automatic optimization indication in response to the trigger on the first interface element, the assistant creation platform 110 may present the adjusted settings information in the optimization panel. The assistant creation platform 110 may, for example, present the adjusted settings information and a further input control in the optimization panel, and the further input control is configured for receiving an input indicating further adjustment of the settings information. For example, as shown in FIG. 3D, the assistant creation platform 110 may present, in response to determining the adjusted settings information, the configuration region 210 shown in FIG. 3D. In FIG. 3D, assistant creation platform 110 may present the adjusted settings information and a further input control in optimization panel 320. The further input control may also include an input box 336, a voice input control, an attachment uploading control, and the like. The assistant creation platform 110 may further adjust the adjusted settings information based on an adjustment indication received via the further input control, for example.

In some embodiments, the assistant creation platform 110 may further present an acceptance control and a rejection control in association with the adjusted settings information in the optimization panel. The assistant creation platform 110 may, in response to receiving a trigger on the acceptance control, determine that an acceptance indication for the at least one adjusted portion of the settings information is received. The acceptance control may include, for example, a replacement control, an insertion control, or the like. In FIG. 3D, the assistant creation platform 110 may further present a replacement control 329 and a rejection control 331 in association with the adjusted settings information in the optimization panel. The assistant creation platform 110 may determine that an acceptance indication for the adjusted settings information is received in response to receiving a trigger on the replacement control 329. The assistant creation platform 110 may, in response to receiving the acceptance indication, determine to accept the adjusted settings information and present the adjusted settings information in the configuration region. For example, the assistant creation platform 110 may replace the previous settings information with the adjusted settings information so as to present the adjusted settings information in the configuration region.

As shown in FIGS. 3D and 3E, the assistant creation platform 110 may present the configuration region 210 as shown in FIG. 3E in response to receiving a trigger on the replacement control 329 in FIG. 3D. The assistant creation platform 110 may replace the previous settings information with the adjusted settings information in the configuration region 210 so as to present the adjusted settings information in the configuration region.

The assistant creation platform 110 may, in response to receiving a trigger on the rejection control, determine that a rejection indication for the at least one adjusted portion of the settings information is received. In FIG. 3D, the assistant creation platform 110 may determine that a rejection indication for the adjusted settings information is received in response to receiving a trigger on the rejection control 331. For example, in response to receiving the rejection indication, the assistant creation platform 110 may determine not to adjust the settings information and continue to maintain the previous settings information.

In some embodiments, the assistant creation platform 110 may also present, in association with the at least one adjusted portion of the settings information in the optimization panel, a regeneration control configured to trigger regeneration of the at least one adjusted portion of the settings information. The assistant creation platform 110 may, in response to receiving a trigger on the regeneration control, regenerate at least one adjusted portion of the settings information, and present the regenerated at least one adjusted portion of the settings information in the optimized panel. In FIG. 3D, the assistant creation platform 110 may further present, in association with the adjusted settings information in the optimization panel 320, a regeneration control 332 configured to trigger the regeneration of the adjusted settings information. The assistant creation platform 110 may regenerate the adjusted settings information in response to receiving a trigger on the regeneration control 332 and present the regenerated adjusted settings information in the optimization panel 320.

The assistant creation platform 110 may further present, in association with the at least one adjusted portion of the settings information in the optimization panel, a copy control configured to copy the at least one adjusted portion of the settings information. The assistant creation platform 110 may copy the at least one portion of the settings information in the optimization panel in response to receiving a trigger on the copy control. In FIG. 3D, the assistant creation platform 110 may further present a copy control 333 configured to copy the adjusted settings information in association with the adjusted settings information in the optimization panel 320. The assistant creation platform 110 may copy the adjusted settings information in the optimization panel 320 in response to receiving a trigger on the copy control 333.

The assistant creation platform 110 may further present, in association with the at least one adjusted portion of the settings information in the optimization panel 320, at least one feedback control configured to trigger uploading of at least one type of feedback information for the at least one adjusted portion of the settings information. In FIG. 3D, the assistant creation platform 110 may further present, in association with the adjusted settings information in the optimization panel 320, at least one feedback control for triggering uploading of at least one type of feedback information for the adjusted settings information. The at least one feedback control may include, for example, a like control 334 and a dislike control 335. The assistant creation platform 110 may determine that the user is satisfied with the adjusted settings information in response to receiving a trigger on the like control 334. In response to receiving a trigger on the dislike control 335, it is determined that the user is unsatisfied with the adjusted settings information. In the process of subsequent adjustment of the settings information, the assistant creation platform 110 may adjust the settings information based on at least one portion of the adjusted settings information that the user is satisfied with. For example, a user-preferred adjustment style may be determined based on at least one portion of the adjusted settings information that the user is satisfied with, and the settings information may be adjusted subsequently based on the adjustment style. The assistant creation platform 110 may refrain from subsequently generating similar settings information based on at least one portion of the settings information that the user is unsatisfied with.

In some embodiments, if the assistant creation platform 110 fails to determine at least one adjusted portion of the settings information (for example, the adjusted settings information is not successfully determined due to the network reason), the assistant creation platform 110 may present the configuration region 210 shown in FIG. 3F. In FIG. 3F, the assistant creation platform 110 may present, in the optimization panel 320, a notice text (e.g., text “Sorry, there were some errors. Please try again later.”) indicating a failure to determine at least one adjusted portion of the settings information.

In some embodiments, in addition to providing, at a fixed location of the configuration region, the first interface element configured for triggering optimization of the entire settings information, the assistant creation platform 110 may further allow the user to perform targeted automatic optimization on a selected portion of the settings information after this portion of the settings information is selected. In response to receiving a selection operation on at least one portion of the settings information, the assistant creation platform 110 may further present, in association with the at least one portion of the settings information, a second interface element for triggering an automatic optimization indication. The assistant creation platform 110 may, for example, directly present the second interface element in response to receiving a selection operation on at least one portion of the settings information. Alternatively or additionally, the assistant creation platform 110 may, for example, present the second interface element in response to a specific user operation after receiving a selection operation on at least one portion of the settings information. The specific user operation may include, for example, a hover operation, a single-click operation, or the like on the at least one portion of the settings information. This is not limited in the embodiments of the present disclosure. As shown in FIG. 3G, the assistant creation platform 110 may present, in response to receiving a selection operation on settings information 303, a second interface element 302 in association with the settings information 303. Similar to the first interface element, the assistant creation platform 110 may detect the automatic optimization indication in response to a trigger on the second interface element 302.

The assistant creation platform 110 may present an optimization panel comprising an input control and/or at least one instruction control in response to detecting an automatic optimization indication for the settings information for the digital assistant. As shown in FIG. 3H, the assistant creation platform 110 may present an optimization panel 340 in response to detecting an automatic optimization indication for the settings information for the digital assistant. The optimization panel 340 may include an input control such as an input box, a voice input control, and an attachment uploading control. It will be appreciated that although not shown in the figure, the optimization panel 340 may similarly include at least one predetermined instruction control.

In some embodiments, if the assistant creation platform 110 detects the automatic optimization indication in response to a trigger on the second interface element, the assistant creation platform 110 may determine the at least one adjusted portion of the settings information based on the adjustment indication and at least one selected portion of the settings information received via the optimization panel. For example, if the user selects content A in the settings information, the assistant creation platform 110 may determine the adjusted content A based on the adjustment indication received via the optimization panel and the content A in the settings information. For example, the assistant creation platform 110 may provide the selected portion of the settings information and the adjustment indication to the second machine learning model to use the second machine learning model to determine the at least one adjusted portion of the settings information.

In some embodiments, to improve the accuracy of determining the at least one adjusted portion of the settings information, the assistant creation platform 110 may provide the entirety of the settings information, the selected portion of the settings information, and the adjustment indication to the second machine learning model. For example, the assistant creation platform 110 may determine an identifier (for example, a paragraph number, a line number, and the like) indicating the selected portion of the settings information, and provide the identifier, the entirety of the settings information, and the adjustment indication to the second machine learning model. The second machine learning model may, for example, determine the selected portion of the settings information based on the identifier and the entirety of the settings information. As such, with the entirety of the settings information being provided together to the second machine learning model, the second machine learning model can learn the context of the selected portion of the settings information and determine the at least one adjusted portion of the settings information based on the context, such that the accuracy of determining the at least one adjusted portion of the settings information can be improved.

For example, the assistant creation platform 110 may present the configuration region 210 as shown in FIG. 31 after determining the at least one adjusted portion of the settings information. The assistant creation platform 110, for example, may present, in the optimization panel 340 of the configuration region 210, the at least one adjusted portion of the settings information, an acceptance control (e.g., replacement control 341), a rejection control 342, a copy control, a regeneration control, at least one feedback control, and an input control 343 configured to receive an input of a further adjustment indication for the settings information. The assistant creation platform 110 may, for example, in response to receiving a trigger on the replacement control 341, determine that an acceptance indication for the at least one adjusted portion of the settings information is received. The assistant creation platform 110 may replace the at least one selected portion in the configuration region with the at least one adjusted portion of the settings information in response to receiving an acceptance indication for the at least one adjusted portion of the settings information. For example, the content A in the settings information in the configuration region may be replaced with the adjusted content A. As shown in FIG. 3J, the assistant creation platform 110 may replace the selected settings information 303 with the at least one adjusted portion of the settings information. The assistant creation platform 110 may present, in the configuration region 210, settings information 304, i.e., the at least one adjusted portion of the settings information.

In some embodiments, the assistant creation platform 110 may further perform targeted automatic optimization on the settings information near a current input location based on an operation of the user on the current input location in the configuration region. The assistant creation platform 110 may further present a third interface element at a current input location in the configuration region for triggering an automatic optimization indication. The assistant creation platform 110 may, for example, present an input cursor in the configuration region indicating the current input location. The interface element (i.e., the third interface element) for triggering the automatic optimization indication may be presented along with the input cursor to facilitate the user to trigger presentation of the optimization panel at any time as needed. The assistant creation platform 110 may, for example, present the third interface element directly near the input cursor. Alternatively or additionally, the assistant creation platform 110 may present the third interface element, for example, in response to receiving a particular user operation on the input cursor. As shown in FIG. 3K, the assistant creation platform 110 may present a third interface element 306 at an input cursor 305 indicating the current input location in the configuration region 210.

Similar to the first interface element and the second interface element, the assistant creation platform 110 may detect the automatic optimization indication in response to a trigger on the third interface element 306. The assistant creation platform 110 may present an optimization panel comprising an input control and/or at least one instruction control in response to detecting the automatic optimization indication for the settings information for the digital assistant. As shown in FIG. 3L, the assistant creation platform 110 may present an optimization panel 350 in response to detecting the automatic optimization indication for the settings information for the digital assistant. The optimization panel 350 may include an input control such as an input box, a voice input control, and an attachment uploading control. It will be appreciated that although not shown in the figure, the optimization panel 350 may also include at least one predetermined instruction control. In some embodiments, if the assistant creation platform 110 detects the automatic optimization indication in response to a trigger on the third interface element, the assistant creation platform 110 may determine an additional portion of the settings information based on the adjustment indication received via the optimization panel and at least one portion of the settings information near the current input location in the configuration region. The assistant creation platform 110 may, for example, provide the adjustment indication received via the optimization panel and the at least one portion of the settings information near the current input location in the configuration region to the second machine learning model to use the second machine learning model to determine the additional portion of the settings information.

In some embodiments, to improve the accuracy of determining the additional portion of the settings information, the assistant creation platform 110 may provide the entirety of the settings information, the adjustment indication received via the optimization panel, and the at least one portion of the settings information near the current input location in the configuration region to the second machine learning model. Likewise, the assistant creation platform 110 may, for example, determine an identifier (for example, a paragraph number, a line number, etc.) indicating the at least one portion of the settings information near the current input location, and provide the identifier, the entirety of the settings information, and the adjustment indication to the second machine learning model. The second machine learning model may, for example, determine the at least one portion of the settings information near the current input location based on the identifier and the entirety of the settings information. As such, with the entirety of the settings information being provided together to the second machine learning model, the second machine learning model can learn the context of the selected settings information and determine the additional portion of the settings information based on the context, such that the accuracy of determining the additional portion of the settings information can be improved.

The assistant creation platform 110, for example, may present the configuration region 210 as shown in FIG. 3M after determining the additional portion of the settings information. The assistant creation platform 110 may, for example, present in the optimization panel 350 of the configuration region 210, an additional portion of the settings information, an acceptance control (e.g., an insertion control 351), a rejection control 352, a copy control, a regeneration control, at least one feedback control, and an input control 353 configured to receive an input of a further adjustment indication for the settings information. The assistant creation platform 110, for example, may determine that an acceptance indication for the additional portion of the settings information is received in response to receiving a trigger on the insertion control 351. The assistant creation platform 110 may insert the additional portion of the settings information at the input cursor 305 indicating the current input location in the configuration region 210 in response to receiving the acceptance indication for the additional portion of the settings information. As shown in FIG. 3N, the assistant creation platform 110 may insert settings information 307, i.e., the additional portion of the settings information, at the input cursor 305 in the configuration region 210.

In summary, in the process of the digital assistant creation according to the embodiments of the present disclosure, the user can adjust the prompt input conveniently and quickly to adjust the response result of the digital assistant accordingly.

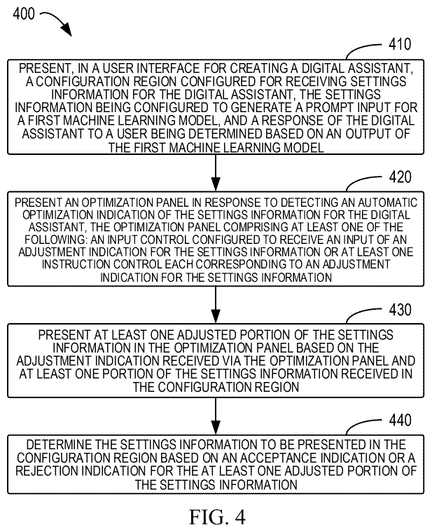

FIG. 4 shows a flowchart of a process 400 for digital assistant creation according to some embodiments of the present disclosure. The process 400 may be implemented at the assistant creation platform 110. The process 400 is described below with reference to FIG. 1.

At block 410, the assistant creation platform 110 presents, in a user interface for creating a digital assistant, a configuration region for receiving settings information for the digital assistant, the settings information being configured to generate a prompt input for a first machine learning model. A response of the digital assistant to a user is determined based on an output of the first machine learning model.

In block 420, the assistant creation platform 110 in response to detecting an automatic optimization indication of the settings information for the digital assistant, presents an optimization panel, the optimization panel comprising at least one of the following: an input control configured to receive an input of an adjustment indication for the settings information, or at least one instruction control each corresponding to an adjustment indication for the settings information.

At block 430, the assistant creation platform 110 presents at least one adjusted portion of the settings information in the optimization panel based on an adjustment indication received via the optimization panel and at least one portion of the settings information received in the configuration region.

At block 440, the assistant creation platform 110 determines the settings information to be presented in the configuration region based on an acceptance indication or a rejection indication for the at least one adjusted portion of the settings information.

In some embodiments, the process 400 further includes: detecting, in response to receiving a trigger on a predetermined interface element in the user interface, the automatic optimization indication of the settings information for the digital assistant.

In some embodiments, the predetermined interface element includes one of: a first interface element presented at a predetermined location in proximity to the configuration region, a second interface element presented in association with at least one portion of the settings information in response to receiving a selection operation on at least one portion of the settings information, or a third interface element presented at a current input location in the configuration region.

In some embodiments, the automatic optimization indication is detected in response to a trigger on the first interface element, and wherein presenting the at least one adjusted portion of the settings information comprises: determining adjusted settings information based on the adjustment indication received via the optimization panel and an entirety of the settings information received in the configuration region; and presenting the adjusted settings information in the optimization panel; and wherein determining the settings information to be presented in the configuration region comprises: in response to receiving the acceptance indication for the adjusted settings information, replacing the settings information in the configuration region with the adjusted settings information.

In some embodiments, the automatic optimization indication is detected in response to a trigger on the second interface element, and wherein presenting the at least one adjusted portion of the settings information comprises: determining the at least one adjusted portion of the settings information based on the adjustment indication received via the optimization panel and the at least one selected portion of the settings information; and wherein determining the settings information to be presented in the configuration region comprises: in response to receiving an acceptance indication for the at least one adjusted portion of the settings information, replacing the at least one selected portion in the configuration region with the at least one adjusted portion of the settings information.

In some embodiments, the automatic optimization indication is detected in response to a trigger on the third interface element, and presenting the at least one adjusted portion of the settings information comprises: determining an additional portion of the settings information based on the adjustment indication received via the optimization panel and at least one portion of the settings information near the current input location in the configuration region; and presenting the additional portion of the settings information in the optimization panel; and wherein determining the settings information to be presented in the configuration region comprises: in response to receiving the acceptance indication for the additional portion of the settings information, inserting the additional portion of the settings information at the current input location in the configuration region.

In some embodiments, presenting the at least one adjusted portion of the settings information comprises: providing at least the adjustment indication received via the optimization panel and the at least one portion of the settings information received in the configuration region to a second machine learning model; determining the at least one adjusted portion of the settings information based on an output of the second machine learning model; and presenting the at least one adjusted portion of the settings information.

In some embodiments, presenting the at least one adjusted portion of the settings information in the optimization panel comprises: presenting, in the optimization panel, the at least one adjusted portion of the settings information and a further input control, the further input control being configured to receive an input comprising a further adjustment indication for the settings information.

In some embodiments, an acceptance control and a rejection control are presented in association with the at least one adjusted portion of the settings information in the optimization panel, and the method further comprises: in response to receiving a trigger on the acceptance control, determining that the acceptance indication for the at least one adjusted portion of the settings information is received; and in response to receiving a trigger on the rejection control, determining that the rejection indication for the at least one adjusted portion of the settings information is received.

In some embodiments, at least one of the following is presented in association with the at least one adjusted portion of the settings information in the optimization panel: a copy control configured to copy the at least one adjusted portion of the settings information, a regeneration control configured to trigger regeneration of the at least one adjusted portion of the settings information, or at least one feedback control configured to trigger uploading of at least one type of feedback information for the at least one adjusted portion of the settings information.

In some embodiments, the at least one instruction control comprises at least one of the following: a first instruction control indicating global adjustment of the settings information, or a second instruction control indicating adjustment of the settings information based on a debugging result of the digital assistant.

In some embodiments, the process 400 further includes: presenting a first input control and a second input control in the optimization panel in response to receiving a trigger on the second instruction control in the optimization panel; receiving, via the first input control, a content to be adjusted in the debugging result of the digital assistant; and receiving, via the second input control, an adjustment target for the content to be adjusted.

In some embodiments, presenting the at least one adjusted portion of the settings information comprises: determining the at least one adjusted portion of the settings information based on the received content to be adjusted, the adjustment target, at least one historical debugging instruction for the digital assistant, and the at least one portion of the settings information received in the configuration region.

In some embodiments, the input control includes at least one of an input box, a voice input control, and an attachment uploading control.

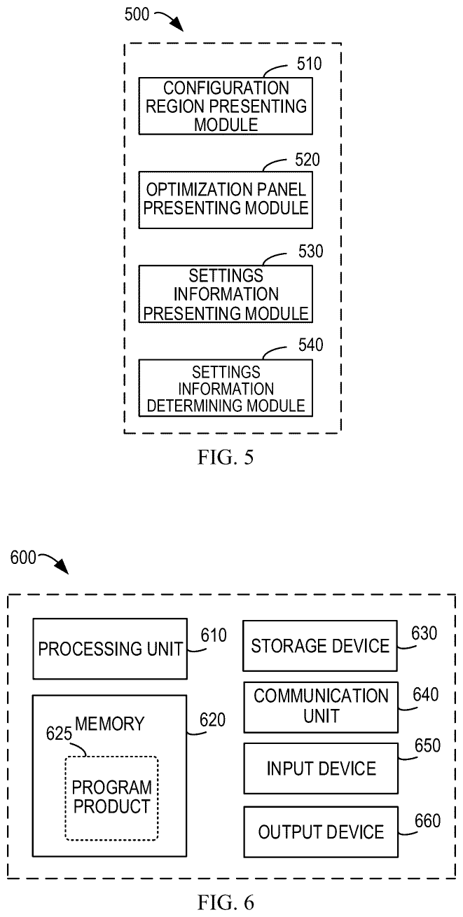

Embodiments of the present disclosure also provide a corresponding apparatus for implementing the above method or process. FIG. 5 shows a schematic structural block diagram of an apparatus 500 for digital assistant creation according to some embodiments of the present disclosure. The apparatus 500 may be implemented, for example, in or included in the assistant creation platform 110. The various modules/components in the apparatus 500 may be implemented by hardware, software, firmware, or any combination thereof.

As shown, the apparatus 500 includes a configuration region presenting module 510 configured to present, in a user interface for creating a digital assistant, a configuration region for receiving settings information for the digital assistant, the settings information being configured for generating a prompt input for a first machine learning model. A response of the digital assistant to a user is determined based on an output of the first machine learning model.

The apparatus 500 further includes an optimization panel presenting module 520 configured to present an optimization panel in response to detecting an automatic optimization indication of the settings information for the digital assistant, the optimization panel comprising at least one of the following: an input control configured to receive an input of an adjustment indication for the settings information or at least one instruction control each corresponding to an adjustment indication for the settings information.

The apparatus 500 further includes a settings information presenting module 530 configured to present at least one adjusted portion of the settings information in the optimization panel based on the adjustment indication received via the optimization panel and at least one portion of the settings information received in the configuration region. The apparatus 500 further includes a settings information determining module 540 configured to determine the settings information to be presented in the configuration region based on an acceptance indication or a rejection indication for the at least one adjusted portion of the settings information.

In some embodiments, the apparatus 500 further includes: an indication detection module configured to, in response to receiving a trigger on a predetermined interface element in the user interface, detect the automatic optimization indication of the settings information for the digital assistant.

In some embodiments, the predetermined interface element comprises one of the following: a first interface element presented at a predetermined location near the configuration region, a second interface element presented in association with at least one portion of the settings information in response to receiving a selection operation on at least one portion of the settings information, or a third interface element presented at a current input location in the configuration region.

In some embodiments, the automatic optimization indication is detected in response to a trigger on the first interface element, and the settings information presenting module 530 includes: a first determination module configured to determine adjusted settings information based on the adjustment indication received via the optimization panel and an entirety of the settings information received in the configuration region; and a first presentation module configured to present the adjusted settings information in the optimization panel; and the settings information determining module 540 includes: a first replacement module configured to, in response to receiving the acceptance indication for the adjusted settings information, replace the settings information in the configuration region with the adjusted settings information.

In some embodiments, the automatic optimization indication is detected in response to triggering of the second interface element, and the settings information presenting module 530 includes: a second determining module, configured to determine the at least one adjusted portion of the settings information based on the adjustment indication received via the optimization panel and the at least one selected portion of the settings information; and the settings information determining module 540 includes: a second replacing module, configured to, in response to receiving an acceptance indication for the at least one adjusted portion of the settings information, replace the at least one selected portion in the configuration region with the at least one adjusted portion of the settings information.

In some embodiments, the automatic optimization indication is detected in response to a trigger on the third interface element, and the settings information presenting module 530 includes: a third determination module configured to determine an additional portion of the settings information based on the adjustment indication received via the optimization panel and at least one portion of the settings information near the current input location in the configuration region; and a second presentation module configured to present the additional portion of the settings information in the optimization panel; and the settings information determining module 540 includes: an insertion module configured to, in response to receiving the acceptance indication for the additional portion of the settings information, insert the additional portion of the settings information at the current input location in the configuration region.

In some embodiments, the settings information presenting module 530 includes: a providing module configured to provide at least the adjustment indication received via the optimization panel and the at least one portion of the settings information received in the configuration region to a second machine learning model; a fourth determining module configured to determine the at least one adjusted portion of the settings information based on a model output fed back by the second machine learning model; and a third presenting module configured to present the at least one adjusted portion of the settings information.

In some embodiments, the settings information presenting module 530 includes: a fourth presenting module, configured to present, in the optimization panel, the at least one adjusted portion of the settings information and a further input control, the further input control being configured for receiving an input of a further adjustment indication for the settings information.

In some embodiments, an acceptance control and a rejection control are presented in association with the at least one adjusted portion of the settings information in the optimization panel, and the apparatus 500 further includes: an acceptance indication determination module configured to, in response to receiving a trigger on the acceptance control, determine that the acceptance indication for the at least one adjusted portion of the settings information is received; and a rejection indication determination module configured to, in response to receiving a trigger on the rejection control, determine that the rejection indication for the at least one adjusted portion of the settings information is received.

In some embodiments, at least one of the following is presented in association with the at least one adjusted portion of the settings information in the optimization panel: a copy control configured to copy the at least one adjusted portion of the settings information, a regeneration control configured to trigger regeneration of the at least one adjusted portion of the settings information, or at least one feedback control configured to trigger uploading of at least one type of feedback information for the at least one adjusted portion of the settings information.

In some embodiments, the at least one instruction control includes at least one of the following: a first instruction control indicating global adjustment of the settings information, or a second instruction control indicating adjustment of the settings information based on a debugging result of the digital assistant.

In some embodiments, the apparatus 500 further includes: an input control presentation module configured to present a first input control and a second input control in the optimization panel in response to receiving a trigger on the second instruction control in the optimization panel; a to-be-adjusted content receiving module configured to receive, via the first input control, a content to be adjusted in the debugging result of the digital assistant; and an adjustment target receiving module configured to receive, via the second input control, an adjustment target for the content to be adjusted.

In some embodiments, the settings information presenting module 530 includes: a fifth determining module, configured to determine the at least one adjusted portion of the settings information based on the received content to be adjusted, the adjustment target, at least one historical debugging instruction for the digital assistant, and the at least one portion of the settings information received in the configuration region.

In some embodiments, the input control includes at least one of an input box, a voice input control, and an attachment uploading control.

The units and/or modules included in the apparatus 500 may be implemented in various manners, comprising software, hardware, firmware, or any combination thereof. In some embodiments, one or more units and/or modules may be implemented using software and/or firmware, such as machine-executable instructions stored on a storage medium. In addition to or as an alternative to the machine-executable instructions, some or all of the units and/or modules in the apparatus 500 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 6 illustrates a block diagram of an electronic device 600 in which one or more embodiments of the present disclosure may be implemented. It would be appreciated that the electronic device 600 illustrated in FIG. 6 is merely exemplary and should not constitute any limitation on the functionality and scope of the embodiments described herein. The electronic device 600 shown in FIG. 6 may include or be implemented as the assistant creation platform 110 of FIG. 1, or the apparatus 500 of FIG. 5.

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to a program stored in the memory 620. In a multiprocessor system, multiple processing units execute computer-executable instructions in parallel to improve the parallel processing capability of the electronic device 600.

The electronic device 600 typically includes a variety of computer storage media. Such media can be any available media that is accessible to the electronic device 600, including but not limited to volatile and non-volatile media, removable and non-removable media. The memory 620 can be volatile memory (such as registers, caches, random access memory (RAM)), nonvolatile memory (such as a read-only memory (ROM), an electrically erasable programmable read-only memory (EEPROM), a flash memory), or some combination thereof. The storage device 630 can be any removable or non-removable medium, and can include machine-readable medium, such as a flash drive, a disk, or any other medium which can be used to store information and/or data and can be accessed within the electronic device 600.

The electronic device 600 may further include additional removable/non-removable, volatile/non-volatile storage medium. Although not shown in FIG. 6, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 620 can include a computer program product 625, which comprises one or more program modules configured to execute various methods or actions of the various embodiments disclosed herein.

The communication unit 640 implements communication with other electronic devices via a communication medium. In addition, functions of components in the electronic device 600 may be implemented by a single computing cluster or multiple computing machines, which can communicate through a communication connection. Therefore, the electronic device 600 may be operated in a networking environment using a logical connection with one or more other servers, a network personal computer (PC), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required. The external device, such as a storage device, a display device, etc., communicate with one or more devices that enable users to interact with the electronic device 600, or communicate with any device (for example, a network card, a modem, etc.) that makes the electronic device 600 communicate with one or more other computing devices. Such communication may be executed via an input/output (I/O) interface (not shown).

According to example implementations of the present disclosure, there is provided a computer-readable storage medium on which computer-executable instructions are stored, wherein the computer-executable instructions are executed by a processor to implement the method described above. According to example implementations of the present disclosure, there is provided a computer program product tangibly stored on a non-transitory computer-readable medium and includes computer-executable instructions. The computer-executable instructions are executed by a processor to implement the method described above.

Various aspects of the present disclosure are described herein with reference to the flow chart and/or the block diagram of the method, the device, the apparatus and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Various implementations of the present disclosure have been described above. The above description is exemplary, not exhaustive, and does not limit to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for digital assistant creation, comprising:
presenting, in a user interface for creating a digital assistant, a configuration region for receiving settings information for the digital assistant, the settings information being configured to generate a prompt input for a first machine learning model, wherein the digital assistant generates a response to a user based on an output of the first machine learning model;
in response to detecting an automatic optimization indication of the settings information for the digital assistant, presenting an optimization panel, the optimization panel comprising at least one of the following:
an input control configured to receive an input of an adjustment indication for the settings information, or
at least one instruction control, each instruction control corresponding to an adjustment indication for the settings information;
presenting at least one adjusted portion of the settings information in the optimization panel based on an adjustment indication received via the optimization panel and at least one portion of the settings information received in the configuration region; and
determining the settings information to be presented in the configuration region based on an acceptance indication or a rejection indication for the at least one adjusted portion of the settings information.

2. The method of claim 1, further comprising:
detecting, in response to receiving a trigger on a predetermined interface element in the user interface, the automatic optimization indication of the settings information for the digital assistant.

3. The method of claim 2, wherein the predetermined interface element comprises one of the following:
a first interface element presented at a predetermined location in proximity to the configuration region,
a second interface element presented in association with at least one portion of the settings information in response to receiving a selection operation on at least one portion of the settings information, or
a third interface element presented at a current input location in the configuration region.

4. The method of claim 3, wherein the automatic optimization indication is detected in response to a trigger on the first interface element, and wherein presenting the at least one adjusted portion of the settings information comprises:
determining adjusted settings information based on the adjustment indication received via the optimization panel and an entirety of the settings information received in the configuration region; and
presenting the adjusted settings information in the optimization panel,
wherein determining the settings information to be presented in the configuration region comprises:
in response to receiving the acceptance indication for the adjusted settings information, replacing the settings information in the configuration region with the adjusted settings information.

5. The method of claim 3, wherein the automatic optimization indication is detected in response to a trigger on the second interface element, and wherein presenting the at least one adjusted portion of the settings information comprises:
determining the at least one adjusted portion of the settings information based on the adjustment indication received via the optimization panel and the at least one selected portion of the settings information,
wherein determining the settings information to be presented in the configuration region comprises:
in response to receiving an acceptance indication for the at least one adjusted portion of the settings information, replacing the at least one selected portion in the configuration region with the at least one adjusted portion of the settings information.

6. The method of claim 4, wherein the automatic optimization indication is detected in response to a trigger on the third interface element, and presenting the at least one adjusted portion of the settings information comprises:
determining an additional portion of the settings information based on the adjustment indication received via the optimization panel and at least one portion of the settings information near the current input location in the configuration region; and
presenting the additional portion of the settings information in the optimization panel,
wherein determining the settings information to be presented in the configuration region comprises:
in response to receiving the acceptance indication for the additional portion of the settings information, inserting the additional portion of the settings information at the current input location in the configuration region.

7. The method of claim 1, wherein presenting the at least one adjusted portion of the settings information comprises:
providing at least the adjustment indication received via the optimization panel and the at least one portion of the settings information received in the configuration region to a second machine learning model;
determining the at least one adjusted portion of the settings information based on an output of the second machine learning model; and
presenting the at least one adjusted portion of the settings information.

8. The method of claim 1, wherein presenting the at least one adjusted portion of the settings information in the optimization panel comprises:
presenting, in the optimization panel, the at least one adjusted portion of the settings information and a further input control, the further input control being configured to receive an input comprising a further adjustment indication for the settings information.

9. The method of claim 1, wherein an acceptance control and a rejection control are presented in association with the at least one adjusted portion of the settings information in the optimization panel, and the method further comprises:
in response to receiving a trigger on the acceptance control, determining that the acceptance indication for the at least one adjusted portion of the settings information is received; or
in response to receiving a trigger on the rejection control, determining that the rejection indication for the at least one adjusted portion of the settings information is received.

10. The method of claim 1, wherein at least one of the following is presented in association with the at least one adjusted portion of the settings information in the optimization panel:
a copy control configured to copy the at least one adjusted portion of the settings information,
a regeneration control configured to trigger regeneration of the at least one adjusted portion of the settings information, or
at least one feedback control configured to trigger uploading of at least one type of feedback information for the at least one adjusted portion of the settings information.

11. The method of claim 1, wherein the at least one instruction control comprises at least one of the following:
a first instruction control indicating global adjustment of the settings information, or
a second instruction control indicating adjustment of the settings information based on a debugging result of the digital assistant.

12. The method of claim 11, further comprising:
presenting a first input control and a second input control in the optimization panel in response to receiving a trigger on the second instruction control in the optimization panel;
receiving, via the first input control, a content to be adjusted in the debugging result of the digital assistant; and
receiving, via the second input control, an adjustment target for the content to be adjusted.

13. The method of claim 12, wherein presenting the at least one adjusted portion of the settings information comprises:
determining the at least one adjusted portion of the settings information based on the received content to be adjusted, the adjustment target, at least one historical debugging instruction for the digital assistant, and the at least one portion of the settings information received in the configuration region.

14. The method of claim 1, wherein the input control comprises at least one of an input box, a voice input control, or an attachment uploading control.

15. An electronic device comprising:
at least one processing unit; and
at least one memory coupled to the at least one processing unit and storing instructions for execution by the at least one processing unit, wherein the instructions, when executed by the at least one processing unit, cause the electronic device to perform operations comprising:
presenting, in a user interface for creating a digital assistant, a configuration region for receiving settings information for the digital assistant, the settings information being configured to generate a prompt input for a first machine learning model, wherein the digital assistant generates a response to a user based on an output of the first machine learning model;
in response to detecting an automatic optimization indication of the settings information for the digital assistant, presenting an optimization panel, the optimization panel comprising at least one of the following:
an input control configured to receive an input of an adjustment indication for the settings information, or
at least one instruction control, each instruction control corresponding to an adjustment indication for the settings information;
presenting at least one adjusted portion of the settings information in the optimization panel based on an adjustment indication received via the optimization panel and at least one portion of the settings information received in the configuration region; and
determining the settings information to be presented in the configuration region based on an acceptance indication or a rejection indication for the at least one adjusted portion of the settings information.

16. The electronic device of claim 15, wherein the operations further comprise:
detecting, in response to receiving a trigger on a predetermined interface element in the user interface, the automatic optimization indication of the settings information for the digital assistant.

17. The electronic device of claim 16, wherein the predetermined interface element comprises one of the following:
a first interface element presented at a predetermined location in proximity to the configuration region,
a second interface element to be presented in association with at least one portion of the settings information in response to receiving a selection operation on at least one portion of the settings information, or
a third interface element presented at a current input location in the configuration region.

18. The electronic device of claim 17, wherein the automatic optimization indication is detected in response to a trigger on the first interface element, and wherein presenting the at least one adjusted portion of the settings information comprises:
determining adjusted settings information based on the adjustment indication received via the optimization panel and an entirety of the settings information received in the configuration region; and
presenting the adjusted settings information in the optimization panel,
wherein determining the settings information to be presented in the configuration region comprises:
in response to receiving the acceptance indication for the adjusted settings information, replacing the settings information in the configuration region with the adjusted settings information.

19. The electronic device of claim 17, wherein the automatic optimization indication is detected in response to a trigger on the second interface element, and wherein presenting the at least one adjusted portion of the settings information comprises:
determining the at least one adjusted portion of the settings information based on the adjustment indication received via the optimization panel and the at least one selected portion of the settings information,
wherein determining the settings information to be presented in the configuration region comprises:
in response to receiving an acceptance indication for the at least one adjusted portion of the settings information, replacing the at least one selected portion in the configuration region with the at least one adjusted portion of the settings information.

20. A non-transitory computer-readable storage medium having a computer program stored thereon, the computer program being executable by a processor to implement a method comprising:
presenting, in a user interface for creating a digital assistant, a configuration region for receiving settings information for the digital assistant, the settings information being configured to generate a prompt input for a first machine learning model, wherein the digital assistant generates a response to a user based on an output of the first machine learning model;
in response to detecting an automatic optimization indication of the settings information for the digital assistant, presenting an optimization panel, the optimization panel comprising at least one of the following:
an input control configured to receive an input of an adjustment indication for the settings information, or
at least one instruction control, each instruction control corresponding to an adjustment indication for the settings information;
presenting at least one adjusted portion of the settings information in the optimization panel based on an adjustment indication received via the optimization panel and at least one portion of the settings information received in the configuration region; and
determining the settings information to be presented in the configuration region based on an acceptance indication or a rejection indication for the at least one adjusted portion of the settings information.
